(19) United States
(12) Patent Application Publication
(10) Pub. No.: US 2026/0270254 A1
(43) Pub. Date: Sep. 10, 2026

(54) ARTIFICIAL INTELLIGENCE ASSISTANT MODULE ASSOCIATED WITH TRACKING AN ELECTRONIC DATA

(71) Applicant: Marvell Asia Pte Ltd, Singapore (SG)

(72) Inventors: Anh Nguyen, Ho Chi Minh City (VN); Trang Duong Tu Cao, Ho Chi Minh City (VN)

(21) Appl. No.: 19/258,649

(22) Filed: Jul. 2, 2025

Related U.S. Application Data
(60) Provisional application No. 63/769,663, filed on Mar. 10, 2025.

(51) Int. Cl. H04L 9/40; G06F 16/2457

(52) U.S. Cl. CPC H04L 63/083; G06F 16/2457

(57) ABSTRACT

A method includes receiving a user entered data associated with tracking/generating an electronic data destined for an electronic tracking system, wherein the user entered data is provided through a graphical user interface (GUI) with a plurality of fields and includes a description associated with the electronic data. The method also includes receiving a user specific data and a historical data associated with the electronic tracking system. The method further includes executing a code associated with an artificial intelligence (AI) module to process the user entered data and based on the user specific data and the historical data to generate a plurality of recommendations associated with a subset of fields of the plurality of fields.

### CROSS-REFERENCE TO RELATED APPLICATIONS

This application claims the benefit and priority to the U.S. Provisional Patent Application Number 63/769,663 filed on Mar. 10, 2025, which is incorporated herein by reference in its entirety.

### BACKGROUND

Use of electronic platforms for requesting a fix, e.g., bug/issue, or for tracking projects has become prevalent. For example, large enterprise organizations use project management tools to track issues, file bug fix requests, assign tasks (to team members), etc. These project management tools provide visibility into issues, workload, accountability, etc., and streamline task management. Moreover, issue/bug tracking and project management tools allow the enterprise clients to collect reports to aid in making decisions such as design sign-off, proposing improvements, address bottlenecks in resolving issues, etc. As such, project efficiency and team collaboration are improved.

In general, a request such as a bug fix ticket is generated by a user by having the user fill out a number of different fields. For example, the request often has a field to include a summary title, a description of the bug/issue, other relevant information, etc. Additionally, the request may include other fields such as priority level, assignment of the request to one or more individuals, notification of the request to a group, etc. More often than not, the person generating the request may mis-categorize the request by allocating the wrong priority, or may be unaware of the correct information to be included, etc., which results in inaccurate and/or incomplete request to be submitted, thereby extending the amount of time to address the request in comparison to a request that is properly filled.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system including an Artificial Intelligence (AI) module communicatively coupled to an electronic tracking system according to one aspect of the present embodiments.

FIGS. 2A-2B depict an example of a graphical user interface (GUI) for filling out a ticket associated with a bug/issue and an AI field filled according to one aspect of the present embodiments.

FIG. 3 depicts an example of a GUI for filling out a ticket for an Information Technology (IT) issue according to one aspect of the present embodiments.

FIG. 4 depicts an example of a system including modules within the AI module for intelligently provide information associated with an electronic tracking system according to one aspect of the present embodiments.

FIG. 5 depicts an illustrative flow diagram for performing a security operation associated with the AI module to provide secure data according to one aspect of the present embodiments.

FIG. 6 depicts another illustrative flow diagram for performing an operation within the AI module to provide privacy-preserved results according to one aspect of the present embodiments.

FIG. 7 depicts an illustrative flow diagram for determining collaborative context associated with an issue/bug and project according to one aspect of the present embodiments.

FIG. 8 depicts an illustrative flow diagram for processing data associated with issue/bug to provide intelligent data associated with the issue/bug and project according to one aspect of the present embodiments.

FIG. 9 is a block diagram illustrating an example of a computing system/device used to support data processing associated with bug/issue and project management to provide intelligent data according to one aspect of the present embodiments.

FIG. 10A-10B depict illustrative examples of a hardware-based programmable system (accelerator) configured to support machine learning and AI related operations according to one aspect of the present embodiments.

FIG. 11 depicts an illustrative example of an accelerator engine including a plurality of processing tiles according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Generally, electronic tracking systems rely on user input to track data. For example, some electronic tracking systems are directed to generating a ticket to address a bug/issue while other electronic tracking system may be directed to tracking program/project management. Regardless of whether the electronic tracking system is for generation of an issue/bug ticket or whether it is to track an issue or project management, there is a need to intelligently assist a person entering a request into the electronic tracking system. The electronic tracking system may be a platform such as project management platform, integrated development environment (IDE) platform, bug/issue tracking platform, project management platform, etc. It is appreciated that the embodiments are described with respect to a design during a system-on-chip (SoC) development project for illustration purposes and should not be construed as limiting the scope of the embodiments.

In one nonlimiting example a verifier reports a logic bug to a designer during an SoC development project. The verifier may use an electronic tracking system for creating or tracking the request, e.g., electronic data associated with bug/issue ticket. A request being generated may include a number of fields that may be fillable and/or selectable (e.g., dropdown menu to select from). It is appreciated that the fields in a request being generated in one enterprise setting may be different from a different enterprise setting. For example, the request (e.g., tickets) being generated in a semiconductor company may be different from a software company.

Typically, the verifier creates a ticket by entering a summary title, a description of the bug, waveform, and any other relevant information in text format for the designer to understand the issue. In one nonlimiting example, the electronic tracking system may include a field for the verifier to select a priority level (Critical/High/Medium/Low) with the priority level set at a default, e.g., medium.

The ticket once generated notifies the project leaders and/or the designer responsible for the feature/component of SoC design associated with the request, e.g., bug/issue. The project leaders and design team may handle multiple tickets and therefore having a priority for each request is valuable for prioritizing the requests. For example, critical tickets may be resolved prior to high-priority tickets, and so on. Moreover, tickets that are accurate and include the complete information, e.g., well-written title and description, help the project leader and design team to understand and resolve the ticket efficiently.

Unfortunately, selection of the wrong priority due to a lack of understanding or a tendency to exaggerate urgency may result in a large number of tickets being marked as high or critical priority where in fact they should have been marked with a different priority. Moreover, in scenarios where the default priority is not changed appropriately may result in wrong prioritization in addressing the request.

Moreover, it is often the case where the person creating the request has a poor title or a vague description for the request. Inadequate or inaccurate information in the request may result in additional and unnecessary back-and-forth communication between the verifier and designer, thereby increasing the turnaround time.

It is appreciated that the priority and description, as discussed above, are merely for illustration purposes only and should not be construed as limiting the scope of the embodiments. For example, inaccurate and/or missing information in other fields, e.g., selection of the designer that the request should be sent to (owner of the feature or component), team members (e.g., other verifiers) that should be copied (“CC”) on the request, whether a hardware bug affects firmware, the severity level of the bug, related components (e.g., hardware blocks), and difficulty in reproducing the bug, etc., in the request form being filled out to be processed by the electronic tracking system for tracking issue/bug and/or project management may also result in increasing the turnaround time for addressing the request. For example, a long “CC” list may include team members that should not be listed while too short “CC” may leave out team members that should be included on the request.

Inaccuracy and/or missing information in the fields (whether optional or required) may be due to the person creating the request being a new-hire, a new project member, etc. Inaccuracies and/or missing information therefore results in additional management overhead and incorrect reports. In certain instances, verifiers may directly contact the designer through systems other than the electronic tracking system, e.g., email, Slack, etc., for tracking bug/issue and/or project management, which results in the issues/bugs not being tracked and therefore going unnoticed by the project lead, which results in inferior product and increase time in addressing the issue at a later stage. Moreover, in a big project and dynamic environment, the design owner may change due to assignment changes or resource turnover, therefore contributing to propagating inaccurate information into the request that is being generated.

Traditionally a tremendous amount of time is spent on training sessions for project members to educate the team members in understanding an electronic tracking system for tracking/generating an electronic data, e.g., issues/bugs and/or project management. Unfortunately, the impact of training is limited due to different absorption levels by team members as well as new members joining after the kick-off of the project often have not had the benefit of the initial training sessions. As such, the onus is often on the project leaders to monitor and correct (often manually) inaccuracies or missing information in the request that is being generated, e.g., by adjusting the priority, adjusting the owner for the feature, by adjusting the team members that should be copied on the email, etc. Some efforts have been made to automatically select the owner, for example, based on the component field and project assignment list but these efforts have been very limited in nature and only to a small number of fields that may require to be updated (manually) as the project unfolds (e.g., the owner of certain feature may change). Some tools have been developed such as Slack and Glean AI to assist users in generating a ticket by chatting with them. Unfortunately, the mentioned traditional user-assisted tools are limited in nature and precision because they are third-party tools and do not benefit from the institutional knowledge of a large enterprise. Additionally, connecting the traditional user-assisted tools such as Slack and Glean AI that are general tools to the electronic tracking system poses a major security risk due to a mismatch between access requirements (e.g., mismatch between access requirement of Slack may be different from that of the electronic tracking system).

The embodiments, presented herein, include an AI module for coupling to the electronic tracking system. The AI module with access to historical data from prior electronic data such as issues/bugs and/or projects may generate a trained model, e.g., a machine learning (ML) model. The AI module is instantiated when the user, e.g., a verifier, is generating a request, e.g., bug/issue ticket. The verifier may input a number of information such as the subject title and the description of the problem and/or accompanying data, e.g., waveform diagram, etc., associated with the issue. The AI module trained with historic data and having access to the enterprise database, e.g., human resources (HR) database, etc., may generate one or more recommendations associated with one or more fields of the request, e.g., recommendation on the identity of the designer (owner) of the feature associated with the issue/bug, identity of other team members (e.g., other verifiers) that should be copied on the request (ticket), etc. In one nonlimiting example, the AI module may also provide a recommendation on the appropriate priority for the request. The recommendations may populate the request in one nonlimiting example and may be user modifiable while in another nonlimiting example the recommendations may be provided to the user for selection thereof. In some embodiments, the system (e.g., AI module) may prompt questions to educate the verifier or to provide additional information to the person creating the request, if the person making the request is modifying the recommendation provided by the AI module. It is appreciated that the fields and the recommendations being provided, as presented herein, are for illustration purposes only and should not be construed as limiting the scope of the embodiments.

In some embodiments, the AI module may also provide recommendations tailored to the user that is creating the request based on the historical data associated with that user. As such a request for the same issue being generated by two different users may result in a different kind of recommendation being provided by tailoring the recommendation to each user. In one nonlimiting example, the AI module may perform security related operations associated with the request being generated to access the appropriate data (e.g., based on security and access profile of the user) in generating the recommendation to ensure security and integrity of the data within the enterprise is preserved. For example, different individuals within the same enterprise may have access to different types of data based on their respective level of security and access profile.

In some embodiments, the AI module may use a ML-based method to learn from past electronic requests, e.g., issue/bug tickets, etc., and further from historical user feedback to generate a model, e.g., ML model. The ML model when used by the AI module may be applied to the generated title/summary/description to adaptively recommend default values for a number of different fields of the request being generated. Accordingly, the larger the amount of data from an enterprise the more accurate and precise the AI module becomes in assisting the users to fill out a request, e.g., bug/issue ticket. The AI model is enterprise-specific (and based on confidential information for that enterprise specifically) and may be targeted to optimize and improve project management. For example, in the context of a bug/issue ticket setting, a verifier engineer may dedicate more time to writing a good title and description of the problem and to rely on the recommendation of the AI module to fill out other fields within the request, e.g., priority, selecting the designer (owner), identifying team members to be copied, other components that may be impacted, etc. The AI module is configured to be added to an existing electronic tracking system, thereby eliminating the need to create a new system with the same functionality. In other words, the AI module is a plug and play component that adds additional flexibility and functionality to the existing electronic tracking system.

It is appreciated that the AI module may be trained to have a different model for different teams, different business units, etc., based on their respective data (historical data that may be confidential). As such, the data and the model for each team or business unit may remain confidential. In some embodiments, the generated AI model may be modified and tuned over time based on additional data that is being processed and further based on feedback from users. It is appreciated that according to some nonlimiting examples, the AI module may be disabled by a user, if desired. It is appreciated that the AI module may be accepted more easily by users because the users are not required to learn a new interface, as often is done with new systems, but rather interface with the same system but more intelligently and more efficiently.

It is appreciated that the embodiments, as described herein, arise out of the computer technology and are inextricably tied to a computer technology. For example, the issue that is being addressed would not have occurred in absence of an electronic tracking system. Moreover, the embodiments, as described herein, leverage enterprise specific data to create an AI model (specific to that enterprise) to more accurately and more precisely provide a recommendation to a user when filling out a request via a GUI while safeguarding the confidentiality of the data (based on user profile and security access profile) as opposed to a generic AI tools without access to company specific data and/or with relaxed safeguards for confidential and proprietary data.

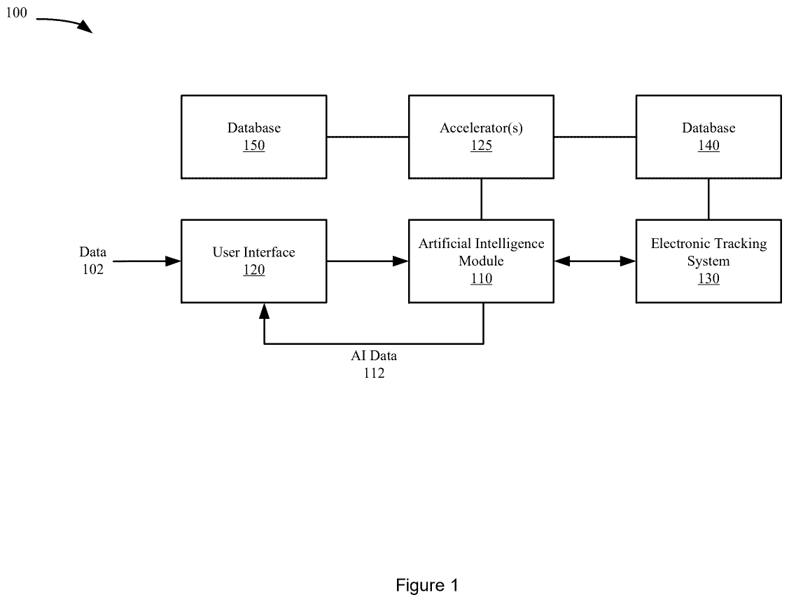

FIG. 1 depicts an example of a system 100 including an AI module communicatively coupled to an electronic tracking system according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The system 100 includes an AI module 110 that is communicatively coupled to an electronic tracking system 130 such as issue (bug) tracking/project management platform. The electronic tracking system 130 is an electronic system that may be used to facilitate a user to generate/track an electronic data, e.g., request, to fix a bug/issue and/or used for project management. The electronic tracking system 130 may have a wide variety of applications, e.g., used in IT services to request bug/issue fix related to IT, used in semiconductor industry to track and/or fix issue/bug with a SoC, etc. Examples of the electronic tracking system 130 include Jira, Azure DevOps, GitHub Issues, etc. It is appreciated that the embodiments are described with respect to semiconductor industry for illustrative purposes and should not be construed as limiting the scope of the embodiments.

In one nonlimiting example, the electronic tracking system 130 facilitates a platform upon which a user may interact with using a user interface 120. The user interface 120 may be a display rendering a GUI associated with the electronic tracking system 130 upon which a user may generate requests, e.g., bug/issue tickets. It is appreciated that the user interface 120 becomes operable when a processor (not shown) runs a code that enables the GUI associated with the electronic tracking system 130 to be rendered.

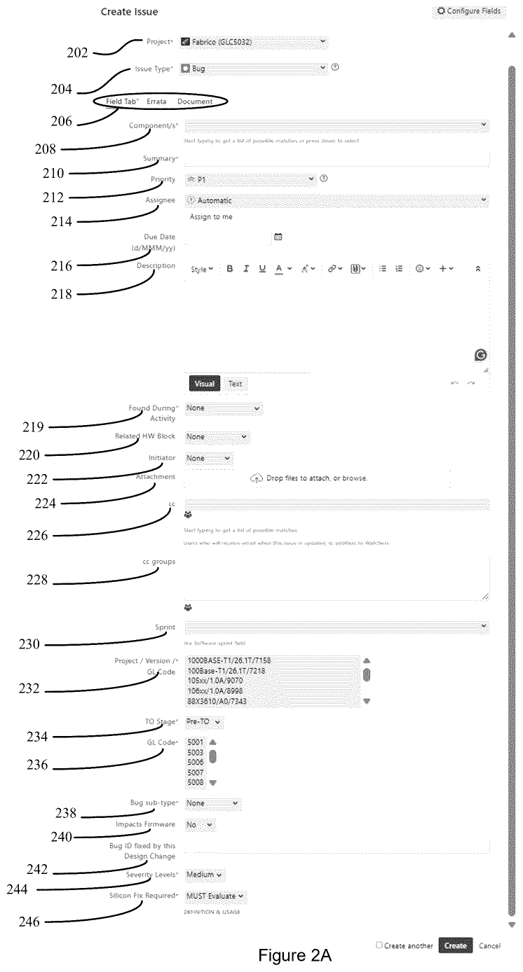

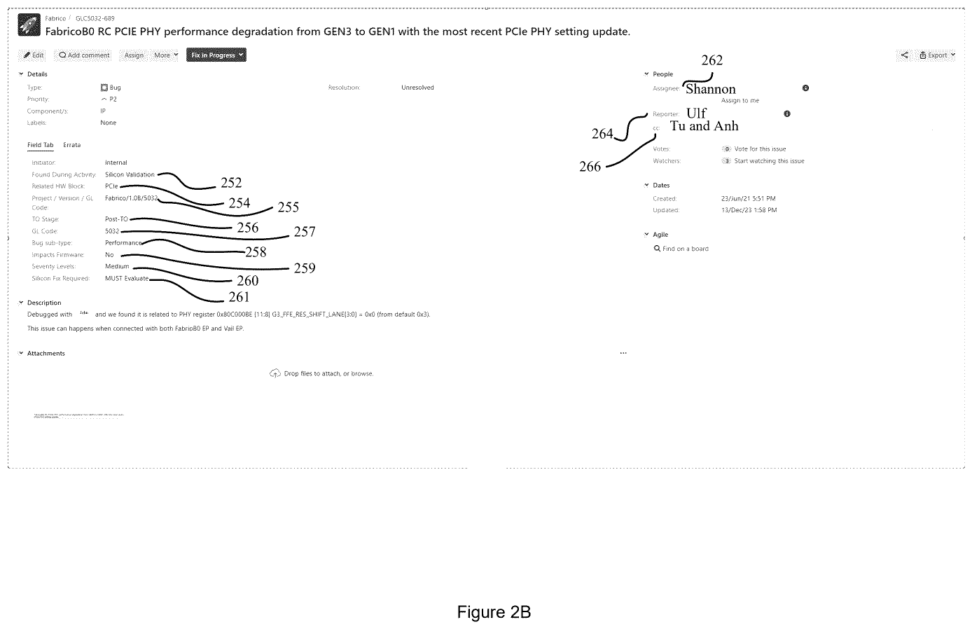

In one nonlimiting example, the electronic tracking system 130 facilitates a GUI to be rendered on the user interface 120. An example of a GUI associated with a semiconductor industry is shown in FIG. 2A. The GUI may include a plurality of fields. In this nonlimiting examples, the fields include 202-246. It is appreciated that each field may be displayed as one or more of a dropdown menu, selectable items, free text input, etc. Field 202 is associated with identification of a project. In this example, the project may be Fabrico (GLC5032). Field 204 is associated with an issue type, e.g., bug. Field 206 is associated with selection of field tab, errata, document. In this example, field tab is selected. Under each field 206 additional fields may be presented. For example, in this nonlimiting example, once the field tab is selected the sub-fields 208-246 may be displayed. It is appreciated that if another field, e.g., errata, was selected then a different set of fields may have been displayed.

Field 208 is associated with identification of a component. Selecting the field 208 enables the user to select the appropriate component from the dropdown menu. The Field 210 is associated with the summary of the issue. In one nonlimiting example, the user may type the summary of the issue encountered. Field 212 is associated with the priority of the issue and may be selected from a number of selectable items in a dropdown menu. The field 212 may be used to determine the level of criticality of the issue. The field 214 is associated with the assignment of the issue to individual, e.g., owner of the feature. In one nonlimiting example, the field 214 may be a dropdown menu that enables the user to select from a number of options, e.g., owners. In one nonlimiting example, the assignment may be made automatically by the system. The field 216 is associated with the date to get the issue/bug resolved.

The field 218 is associated with the description of the issue/bug. In one nonlimiting example, the issue/bug may be described in freestyle format in the designated user input area. For example, a user may type “Debugged with John and we found it is related to PHY register 0×80C000BE [11:8] G3_FFE_RES_SHIFT_LANE[3:0]=0×0 (from default 0×3). This issue can happen when connected with both FabrioB0 EP and Vail EP.” The field 219 is associated with the when the issue/bug was found. The field 220 is associated with identification of related components, e.g., related hardware block, and may be selected form a dropdown menu. It is appreciated that depending on the project each of the dropdown menus for each field may present a different selectable option. For example, in a project different from Fabrico (GLC5032), the selectable related hardware components may be different from that of Fabrico (GLC5032).

The field 222 is associated with the initiator of the request being generated and may be selected from a dropdown menu. The field 224 is associated with any document associated with the bug/issue. For example, the user may drop a supporting file in the field 224 when the request is being generated. The field 226 is associated with individuals and field 228 is associated with groups that may need to be notified about this issue/bug. For example, other verifiers working on a similar project may be included to notify them of the issue/bug detected and any resolution thereafter.

The field 230 is associated with sprint that refers to a fixed, short period of time during which a development team works to complete a specific amount of work. The field 232 may be associated with the project/version/GLcode. In this example, a number of selectable projects/versions/GLcodes are presented, e.g., 1000BASE-T1/26.1T/7158, 100Base-T1/26.1T/7218, 105xx/1.0A/9070, 106xx/1.0A/8998, 88X 3610/A0/7343, etc. The field 234 may be associated with whether the stage of the project is related to prior to tape-out (TO) or after TO. The field 236 may be associated with the GL code and may include a number of selectable items, e.g., 5001, 5003, 5006, 5007, 5008, etc. The field 238 is associated with sub-type for the bug being reported. The field 240 is associated with the determination of whether the bug/issue impacts the firmware. The field 242 is associated with bug identification fixed by the design change. The field 244 is associated with the level of severity of the bug/issue. The field 246 is associated with whether silicon fix is required and may have a number of selectable items including “Must evaluate”.

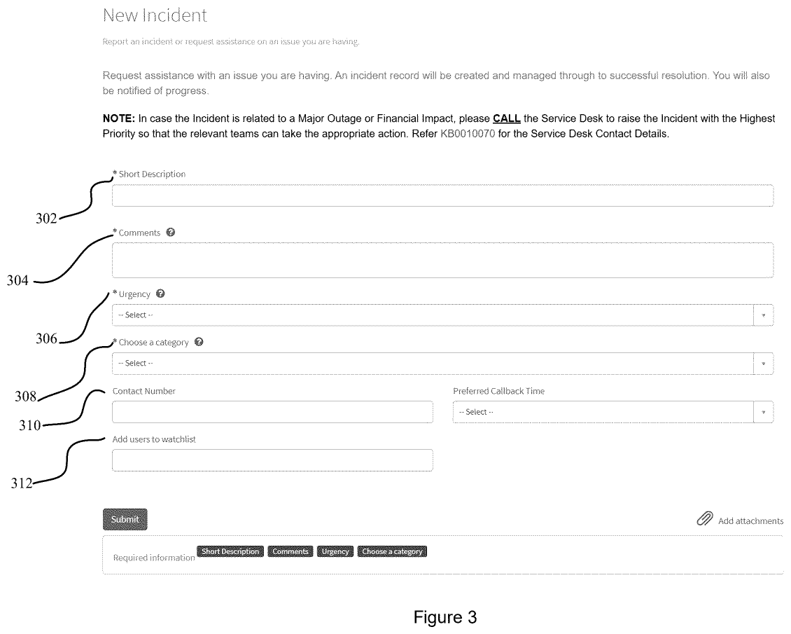

An example of a GUI associated with an IT industry is shown in FIG. 3. The GUI may include a number of fields 302-312. The field 302 is associated with the description of the issue whereas field 304 is associated with comments for the issue. Field 306 is associated with the urgency of the issue and field 308 is associated with selection of a category, e.g., operating system, hardware, etc. Field 310 is associated with the contact number and field 312 is associated with identifying users to be added.

As illustrated, depending on the industry the GUI being rendered may be different. As such, the number of the fields and the type of information for each field may vary from one industry to the next and there may be variations even within the same industry from one enterprise to another. As such, the particular fields being rendered and the type of information that are discussed are for illustrative purposes and should not be construed as limiting the scope of the embodiments.

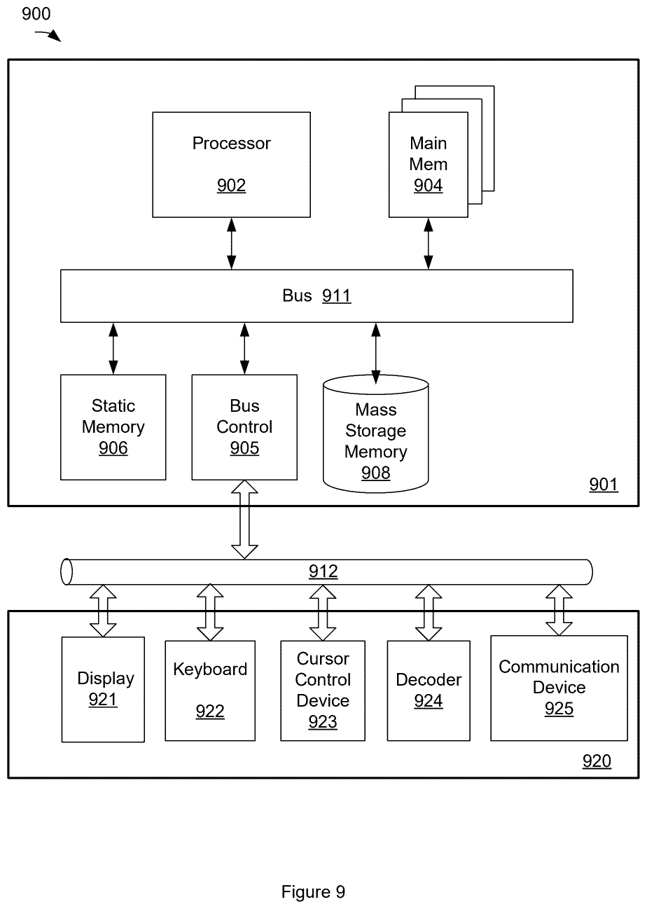

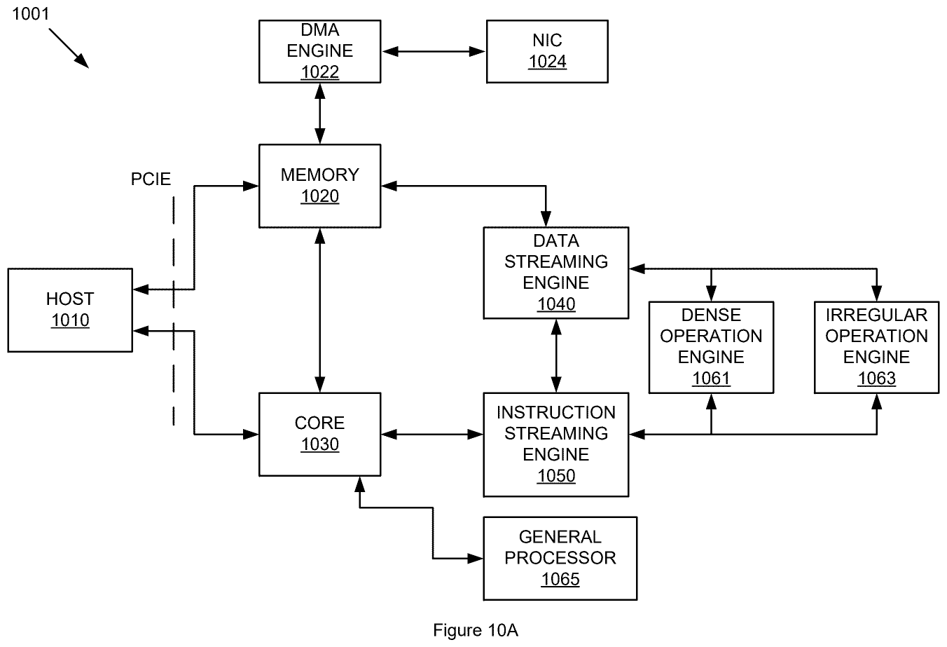

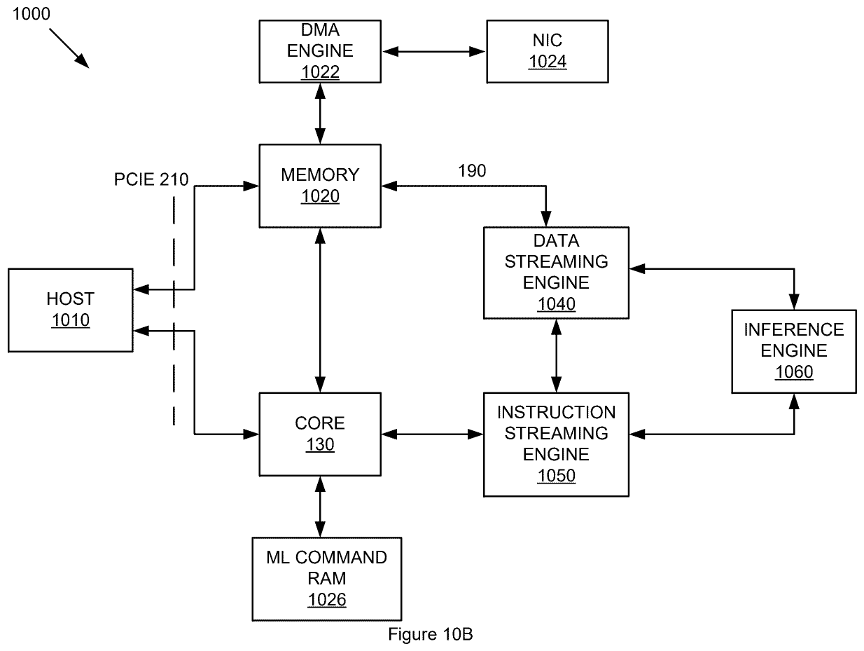

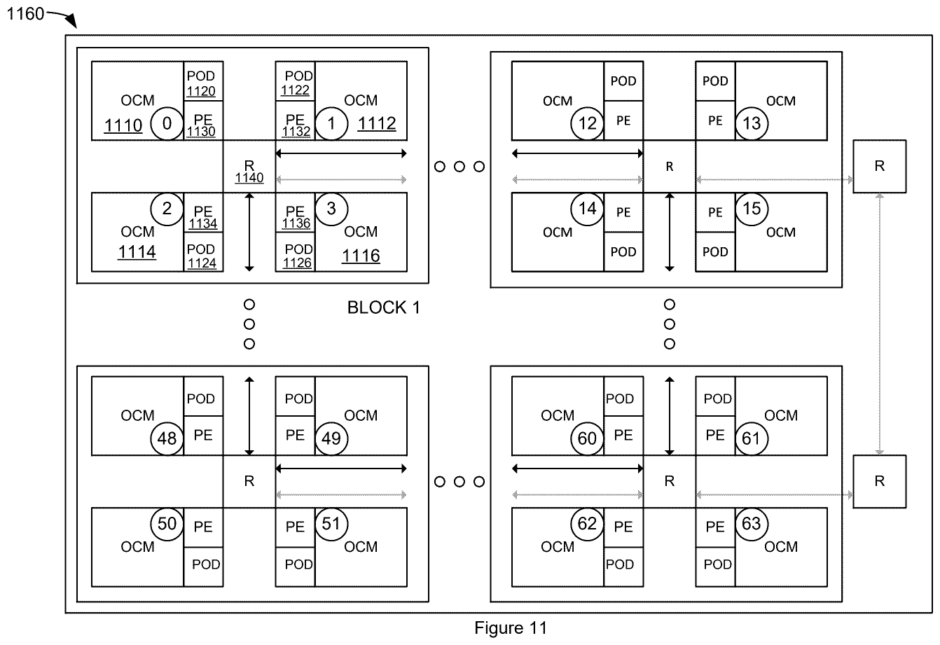

Once the GUI is rendered, the user may enter the appropriate fields of the GUI via the user interface 120 to generate a request, e.g., ticket for a bug/issue. For example, the user may provide data 102 (also referred to as user entered data) to the user interface 120 to fill out one or more fields of the GUI. In this nonlimiting example, the user may enter a subset of the information for the GUI. For example, the user may fill out the fields associated with the title and a description of the issue/bug. The data 102 is transmitted and is received by the AI module 110 instead of the electronic tracking system 130. The AI module 110 is instantiated by a processor, e.g., accelerators 125. Examples associated with accelerators 125 are described with respect to FIGS. 10A-11. The AI module 110 may in one nonlimiting example be instantiated by a computer system, as described in FIG. 9. It is appreciated that the accelerators 125 may enable faster processing of data.

The AI module 110 may include one or more AI models that may have been generated prior to receiving the data 102. The AI model may be a ML model in one nonlimiting example. It is appreciated that according to one nonlimiting example, the AI model is generated a processor, e.g., by the accelerators 125, based on historical data (stored in a database 140) associated with prior requests, e.g., prior issue/bug tickets from the electronic tracking system 130.

In some embodiments, the AI model may be a model that has been generated based on training using the prior requests associated with the electronic tracking system 130. The AI model may receive a number of data as its input, e.g., description of the issue, summary/title of the issue, etc., and based on that it may determine the proper output. The proper output in one nonlimiting example may be a plurality of recommendations associated with one or more fields of the GUI request that is being filled out. For example, based on the fields 218 and/or 210, the AI model may provide a plurality of recommendations for the fields 212, 214, 220, 228, 232, 234, 236, 244, etc.

Accordingly, the user is no longer burdened with having to fill out all the fields in the GUI or even worse have missing information or inaccurate information in the request. Instead, the AI module 110 leverages historical data, stored in the database 140, from the electronic tracking system 130 to more precisely and more reliably fill out the GUI request and to provide recommendations to the user. For example, the AI module 110 may recommend that based on the description of the issue/bug the priority should be set at high. In one nonlimiting example, the one or more recommendations from the AI module 110 may be the set values in the GUI request being filled out or may be recommendations provided to the user for selection thereof. The recommendations may be provided as AI data 112 to the user and may be rendered to the user via the user interface 120. It is appreciated that in one nonlimiting example, the user may be allowed to modify the recommendations. According to one nonlimiting example, the AI module 110 may render additional information, e.g., questions, to the user before enabling the user to modify the AI data 112 to ensure veracity of the information.

It is appreciated that in some embodiments, the AI model may be further improved by tailoring the model based on the user specific information stored in a database 150. For example, the database 150 may contain HR resources that may be used to identify team members working on a particular project associated with the bug/issue, title of the user generating the request to identify other team members that may be impacted, etc. It is appreciated that the user specific information stored in the database 150 may further be used to provide access to data to the user based on the user profile and/or security access. In one nonlimiting example, the user specific data stored in the database 150 may include one or more user specific preferences or user specific prior requests (e.g., prior issue/bug tickets). It is appreciated that the database 150 may also store additional data such as technical expertise, work patterns, collaboration networks, project context, user interface preferences, performance metrics, technical environment, learning patterns, etc.

Technical expertise may include data such as programming languages, hardware/software specifications, certifications, domain expertise levels, etc. As a nonlimiting example, the electronic tracking system may track that an engineer may have expert-level knowledge in peripheral component interconnect express (PCIe) interfaces and field programmable gate array (FPGA) programming with intermediate knowledge of power management and advanced training in signal integrity analysis, and to store that information in the database 150.

Work patterns may include availability windows, response metrics, resolution approaches, task prioritization tendencies, etc. As a nonlimiting example, the electronic tracking system may record that a particular manager reviews tickets between 8-10 am, responds to critical issues within 30 minutes, prefers to address security issues before performance issues, and often delegates user interface related tasks, and to store that information in the database 150.

Collaboration networks may include data such as frequent collaborators, cross-functional relationships, mentorship connections, team communication preferences, etc. As a nonlimiting example, the electronic tracking system may track that a developer may regularly collaborate with a particular member (e.g., John) on memory management issues, mentors three junior engineers on the firmware team, and prefers technical discussions via code comments rather than meetings, and to store that information in the database 150.

Project context may include current/past assignments, role responsibilities, access permissions, milestone contributions, etc. As a nonlimiting example, the electronic tracking system may track that a designer is currently assigned to a particular project for power management module and that has previously led the clock distribution design on a different project, has read/written access to the analog team's repositories, and has delivered critical phase-locked loop components ahead of schedule, and to store that information in the database 150.

User interface preferences may include dashboard layouts, saved searches, notification settings, custom field configurations, etc. As a nonlimiting example, the electronic tracking system may track that a tester prefers a dashboard showing only critical bugs, has saved searches for “USB connectivity issues” and “sleep mode failures”, wants email notifications only for blocker issues, and has configured custom fields to track reproduction steps in detail, and to store that information in the database 150.

The performance metrics may include issue quality ratings, categorization accuracy, solution effectiveness, knowledge contributions, etc. As a nonlimiting example, the electronic tracking system may track that a particular manager's bug report receive an average quality score of 4.8/5, that are correctly categorized 95% of the time, lead to permanent fixes in 87% of cases, and have contributed 23 entries to the knowledge base in the past quarter, and to store that information in the database 150.

Technical environment may include development environments, test configurations, hardware requirements, compatibility constraints, etc. As a nonlimiting example, the electronic tracking system may track that the a particular developer typically works in a Linux environment with kernel version 5.15, tests on reference hardware platform version 3.2, requires access to specialized oscilloscope equipment, and needs compatibility with legacy protocol version 2.1, and to store that information in the database 150.

Learning patterns may include feedback responses, skill development trajectory, adaption to new processes, etc. As a nonlimiting example, the electronic tracking system may track that a particular engineer typically implements feedback within 2 days, has shown rapid skill development in radio frequency (RF) design over the past 6 months, quickly adopted the new simulation workflow, and regularly completes optional training modules, and to store that information in the database 150.

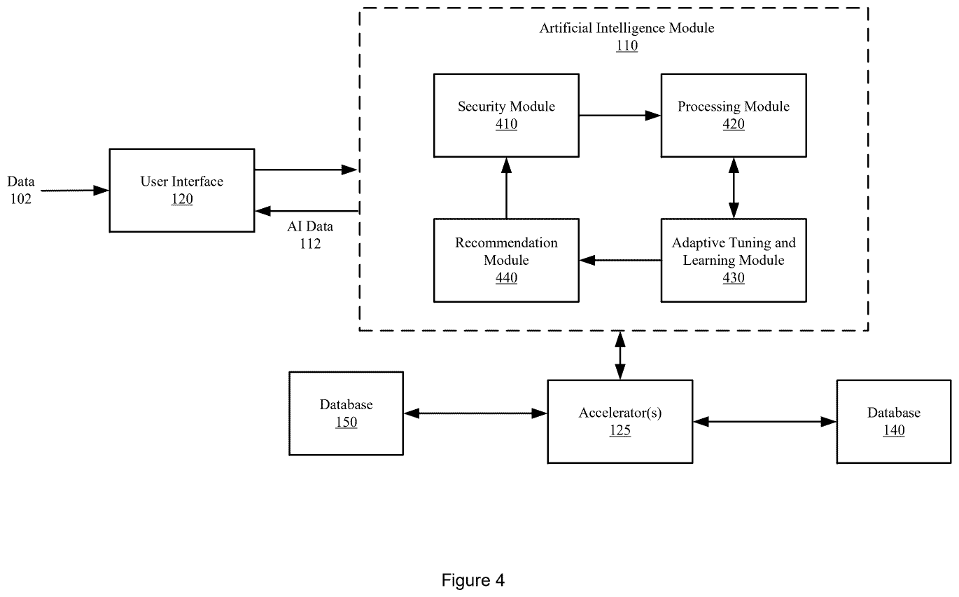

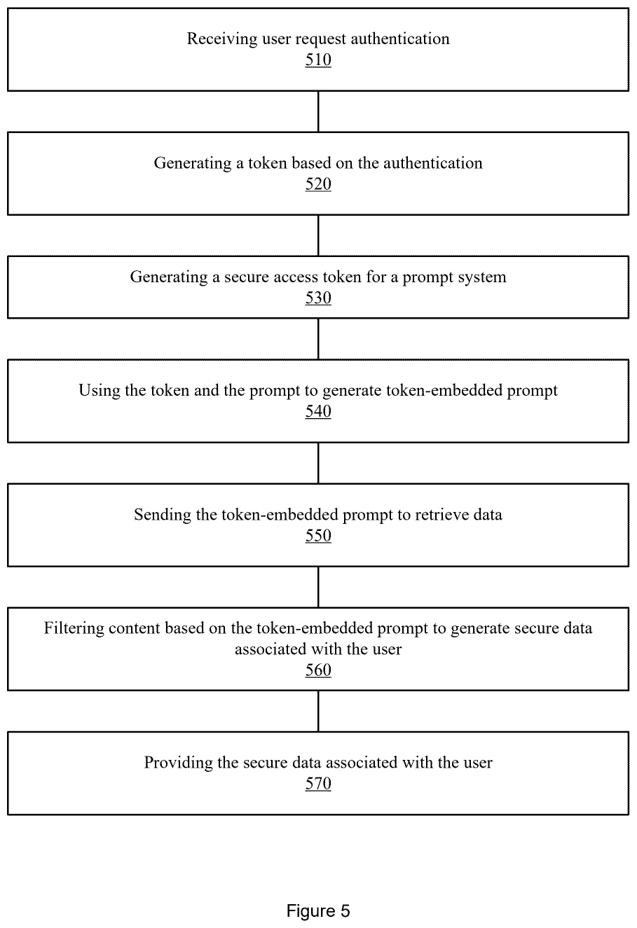

It is appreciated that the AI model may be one or more models. For example, each group or project may have its own dedicated AI model. As such, discussions with respect to a single AI model is for illustrative purposes only and should not be construed as limiting the scope of the embodiments. It is appreciated that the AI model may comply with security/access requirements associated with data. It is appreciated that one or more operations associated with security and/or access are described in greater detail with respect to FIGS. 4 and 5 below.

Accordingly, the AI module 110 enables a user, e.g., verifier, to provide data associated with a subset of the fields in the GUI, e.g., description of the issue/bug. The AI module 110 based on the AI model (generated by training based on historical data from the electronic tracking system 130) may analyze the data 102 and generate one or more recommendations, e.g., AI data 112, that can be used to fill out the request in the GUI. It is appreciated that the recommendations in one nonlimiting may be further tailored based on the user specific data, e.g., user preferences, etc. In other words, the AI module 110 enables the user to focus on a subset of fields of the GUI associated with the electronic tracking system 130 and for the AI module 110 to provide recommendation with respect to other fields of the GUI. The recommendation may be a set value by the AI module 110 or may be a selectable option that a user may select, if desired. As such, the user is no longer needed to guess or miss categorize or provide inaccurate information that may result in delay in the processing of the request. Rather the AI module 110 uses historical data and based on the AI model provides a number of recommendations associated with the request. Thus, not only the time required by the user to create the request is reduced, but the accuracy of the information provided is improved by relying on the AI module 110 and the time required to address the issue/bug is reduced by identifying the correct individuals/group to handle the issue/bug and to provide that group/individuals with the correct information.

Accordingly, large amount of data (prior historical data such as prior tickets for bugs/issues, etc.) from an enterprise may be used to provide insights into an active request being generated by generating an AI model based on the prior historical data. As described, the AI model is enterprise-specific (and based on confidential information for that enterprise specifically) and may be targeted to optimize and improve project management. For example, in the context of a bug/issue ticket setting, a verifier engineer may dedicate more time to writing a good title and description of the problem and to rely on the recommendation of the AI module 110 to fill out other fields within the request, e.g., priority, selecting the designer (owner), identifying team members to be copied, other components that may be impacted, etc. The AI module 110 is independent and separate from the electronic tracking system 130. As such, the AI module 110 is configured to be added to an existing the electronic tracking system 130, thereby eliminating the need to create a new system with the same functionality. In other words, the AI module 110 is a plug and play component that adds additional flexibility and functionality to the existing electronic tracking system.

It is appreciated that in some embodiments, the AI model may be fine tuned and modified over time with the updated data. For example, the request being generated by a user may be stored in the database 140 such that the AI model can later be modified and updated. Accordingly, the AI model evolves over time as projects and products evolve over time. It is also appreciated that in one nonlimiting example, the database 150 is updated over time with user specific information such as changes to title, changes to project, changes to group members, etc., that can be used to further tailor the recommendations to the user and to further ensure that confidentiality of data is maintained even within the same enterprise from one group to the next.

Referring now to FIG. 2B, an example of the GUI filled out by the AI module 110 after the data 102 that contains the description of the issue/bug is provided. In one nonlimiting example, the AI module 110 generates a filled out form (GUI), as shown in FIG. 2B based on the description of the issue/bug being requested or generated by the verifier. In this nonlimiting example, the AI module 110 provides a plurality of recommendations based on the description of the issue/bug provided as data 102. The description may be “Debugged with John and we found it is related to PHY register 0×80C000BE [11:8] G3_FFE_RES_SHIFT_LANE[3:0]=0×0 (from default 0×3). This issue can happen when connected with both FabrioB0 EP and Vail EP” and the AI module 110 may provide recommendations associated with fields 252-266. In one nonlimiting example, the AI module 110 may determine the priority to be “P2” and the type of the request as “Bug” based on the description that is provided by the verifier through data 102. The recommendation may be presented to the user (e.g., verifier) for selection thereof or may be provided as values in the fields 252-266.

In one nonlimiting example, the AI module 110 determines that the proper recommendation for the field 252 is “silicon validation” to indicate that the issue occurred during evaluation board level. In one nonlimiting example, the AI module 110 determines that the proper recommendation for the field 254 for related hardware block is “PCIe”. In one nonlimiting example, the AI module 110 determines that the proper recommendation for the field 255 for project/version/GL code is “Fabrico/1.0B/5032”. In one nonlimiting example, the AI module 110 determines that the proper recommendation for the field 256 associated with the tape-out stage is “post-TO”. In one nonlimiting example, the AI module 110 determines that the proper recommendation for the field 257 associated with the GL code is “5032”. In one nonlimiting example, the AI module 110 determines that the proper recommendation for the field 258 associated with the bug sub-type is “performance”. In one nonlimiting example, the AI module 110 determines that the proper recommendation for the field 259 associated with whether it impacts firmware is “No”. In one nonlimiting example, the AI module 110 determines that the proper recommendation for the field 260 associated with the severity level is “Medium”. In one nonlimiting example, the AI module 110 determines that the proper recommendation for the field 261 associated with whether silicon fix is required is “Must evaluate”. It is appreciated that in some examples, the AI module 110 determines that the proper recommendation for the field 262 associated with the assignee of the feature (e.g., owner) is “Shannon”. In one nonlimiting example, the AI module 110 determines that the proper recommendation for the field 264 associated with the person reporting the issue/bug or creating the request is “Ulf”. In one nonlimiting example, the AI module 110 determines that the proper recommendation for the field 266 associated with the individuals or teams that are to be notified or “CC” is “Tu and Anh”.

It is appreciated that the fields may vary from one enterprise to the next and even from one group to another within the same enterprise. As such, the types of fields, the number of fields, etc., that are described above are for illustration purposes only and should not be construed as limiting the scope of the embodiments. Moreover, the AI module 110 providing recommendations for a number of fields based on the description and/or summary of the description and/or the title of the request is for illustrative purposes and should not be construed as limiting the scope of the embodiments. The embodiments are directed to the AI module 110 leveraging historical data (e.g., prior tickets/requests within the same enterprise or group within the same enterprise) to generate an AI model that can be used to assist the user generating a request/ticket to fill out a number of fields by providing a plurality of recommendations. In this example, the AI module 110 provides a plurality of recommendations with respect to a number of fields within the request being generated for the electronic tracking system 130 based on at least one of the title, the summary of the request/issue, and the description of the request/issue.

It is appreciated that the recommendation provided to the user may be user modifiable. For example, the user may desire to modify field 254 and add additional hardware components to “PCIe” such as Network on a chip (“Noc”) or to remove the recommendation such as “PCIe” and to add “Noc” instead. According to one nonlimiting example, the AI module 110 may render a number of outputs, e.g., audio output, display output, etc., to the user before modification can take place. For example, the AI module 110 may provide a number of questions to the user and in response to the answers provided allow the user to modify the recommendation in order to ensure accuracy and veracity of the information being modified. It is appreciated that once the request is generated and the fields are filled out based on the recommendations by the AI module 110, the request may be transmitted to the electronic tracking system 130 for processing and for the issue/bug to be addressed.

FIG. 4 depicts an example of a system including modules within the AI module for intelligently providing information associated with an electronic tracking system according to one aspect of the present embodiments. The AI module 110 includes a number of different modules such as security module 410, processing module 420, adaptive tuning and learning module 430, and a recommendation module 440.

The adaptive tuning and the learning module 430 may access historical data by accessing the database 140 to generate an AI model, as described above, or to tune and modify the AI model based on updated data. For example, the adaptive turning and learning module 430 may receive operational logs (e.g., historical requests from the electronic tracking system 130 or from the database where the historical data is stored), access events (e.g., user login and authentication attempts, permission checks when accessing data, attempts to access data across project boundaries, security warning and violation records, security token creation and verification, etc.), usage data (e.g., features that the users actually use, search patterns and query types, how users response to AI recommendations, the fields that users modify after the AI recommendations/suggestions, how team collaborate on tickets, etc.), performance metrics (e.g., accuracy of AI predictions, how quickly the system responds, frequency that AI correctly identifies issue types, user satisfaction and recommendations, time saved compared to manual ticket creation), etc. As a nonlimiting example, when a particular engineer attempts to access data that only a particular manager has access to, the access event that the particular engineer attempted to access this and was denied may be recorded and a message may be displayed that the manager has expertise in this area and has offered to help the team and whether the manager should be contacted. As a nonlimiting example, the usage data may be that a particular team typically ignores priority recommendations but accepts assignee suggestions and as such the priority algorithm may be improved while maintaining the effective assignee matching. As a nonlimiting example, the performance metrics may be that a designer team complete tickets 30% faster when AI recommendation is used in comparison to manual entry, thereby the metric may be used to identify which recommendation types save the most time and to improve others.

The adaptive tuning and the learning module 430 may then perform one or more of pattern analysis, anomaly detection, model optimization, compliance verification, etc., and may output the AI model with security updates, processing optimization, adjusted filtering and system improvements. It is appreciated that the generation of the AI model may occur once and be updated from time to time. Moreover, it is appreciated that the adaptive tuning and the learning module 430 may further access user specific data by accessing the database 150, e.g., the user's work habits and preferences, data associated with recommendations that worked in the past, etc., to further tailor the AI model for each specific user or group of users to generate personalized results for each user. For example, user specific data such as the user prioritizing security bugs as highest may be used by the system to generate a specific AI model to rank security related issues at the top of the dashboard. The AI model that is generated may be stored for later retrieval.

The security module 410 is configured to process data 102 and provide access to users based on their credentials and security/access profile. For example, the security module 410 is configured to check whether the user has permissions to access certain data (or for data to be used by the AI module to create a recommendation for the user) and further to create security boundaries for safe data access. As an example, for an engineer to access PCIe bug information or for recommendation to be created associated with the PCIe bug information, the security module 410 may verify that the user has PCIe subsystem access rights before retrieving the data associated therewith. The security module 410 ensures that sensitive data is provided to users with the appropriate level of security and credentials and it protects the enterprise's private information. The security module 410 may receive a number of inputs, some of which are provided as part of data 102. For example, the security module 410 may receive user authentication credentials, compliance parameters (e.g., privacy rules settings like GDPR or HIPAA, industry security standards such as ISO 27001, company security rules, project secrecy agreements, data storage time limits, etc.), security policies (e.g., rules regarding sharing between projects, individuals that can access information based on job role, handling secret information, login requirements for sensitive data, the duration that security passes last, etc.), etc. As a nonlimiting example, the compliance parameters may be that a particular project has a medical date and as such HIPAA rules apply and as such the engineer may access anonymized patient data while a doctor may have full access. As a nonlimiting example, the security policy may be that a particular manager has access to a particular information (e.g., a particular memory controller design) while an engineer does not have access to this information but the particular manager has declared willingness to help so the system may recommend “contact manager for insight on memory controller design” rather than exposing the restricted information directly.

The security module 410 may then process the data to perform at least one or more of authentication verification of the user, permission calculations (e.g., job role access rights, project specific access, team membership access, temporary access for collaboration, access for people with multiple roles, etc.), policy enforcement (e.g., security pass checks at each step, content filtering based on clearance, security limits in search queries, hiding sensitive parts of documents, security token verification, etc.), security boundary determination (e.g., project walls to prevent unauthorized access, team information sharing limits, job role access restrictions, data secrecy level limits, time-limited access windows, etc.), etc. The security module 410 may output permission boundaries (e.g., field-level data access (certain fields may be visible while others may not), action-specific permissions, time-limited access that expires, access that changes based on project phase, team relationship access limits, etc.), access controls, security tokens, and/or audit events. As a nonlimiting example, the permission calculation may be that a tester joins a project temporarily and for that tester to have read-only access to the code for a certain period, e.g., 2 weeks, without ability to view customer data that a developer can view. As a nonlimiting example, the policy enforcement may be a manager searching for a particular chip design and having access to all results whereas an engineer making a similar search may have access to a subset of the results. As a nonlimiting example, the security boundary determination may be when a team working on power system can share circuit diagram with another team working on cooling but neither teams can view another team's security encryption code. As a nonlimiting example, permission boundaries may be that during a design review a reviewer has view access and ability to comment on a schematic without the ability to edit while after approval a builder may be able to view but not comment or edit. Accordingly, the security module 410 is configured to manage access control, data protection, and token-based verification. The security module 410 includes a role-based authorization, context-sensitive access determination engine, unified data protection module, and token-based access verification protocol, to name a few. As such, the security module 410 is configured to enforce security boundaries based on user context and roles, and is further configured to process authentication and to generate security tokens.

In one nonlimiting example, the security module 410 is configured to extend permissions using team context (e.g., providing other team members the same/similar access). In other words, token is extended based on team relationships, delegated permission encoding, and/or cryptographic signature chaining. In one nonlimiting example, the security module 410 may utilize a permission proxy based on the extended token to create delegated permissions. In other words, contextually relevant team members (from the context) may be given permission or access to data. In one nonlimiting example, the security module 410 may utilize access delegate to combine permissions with resource information to create access requests that may be used by to gather data securely. The security module 410 may also be configured to enforce security constraints on retrieval operations, e.g., data collected such as user specific data and/or team specific data, etc. In one nonlimiting example, the results may be aggregated and tracked for auditing and/or filtered for security before being delivered to the user.

The processing module 420 is configured to process the data 102, e.g., description of the issue/bug, as well as receiving the security related information from the security module 410. In one nonlimiting example, the processing module 420 is configured to process similar past tickets from historical data, e.g., by accessing the database 140, team information from user specific data, e.g., by accessing the database 150, and to process the historical data to find a match between historical pattern to the current issues. For example, a tester may have submitted a memory leak bug and the processing module 420 may access three similar bugs from last year in a particular project and identifies another engineer who fixed those bugs on the tester's team. In one nonlimiting example, the processing module 420 receives user queries that may be part of the data 102 (e.g., bug/issue description entered by users, problem summaries and titles, search terms used to find similar issues, questions associated with component interactions, feature requests and enhancement descriptions, etc.), contextual parameters (e.g., current project phase such as design/development/testing, user's role and expertise level, device/platform being worked on, related components or subsystems, priority and severity indicators, etc.), permission boundaries (e.g., project-specific visibility limits, team-based information access controls, role-based feature access restrictions, time-limited collaboration windows, data classification access threshold, etc.), etc. A nonlimiting example of user queries may be that a tester enters “USB device not recognized after sleep mode” as a bug description. A nonlimiting example of the contextual parameters may be when a developer reports a bug and the system automatically includes that it is during the Beta phase on the Windows platform for networking subsystem with the developer's expertise in driver development. A nonlimiting example of permission boundaries may be when a manager views bug reports related to a particular knowledge the manager is able to view complete details while certain fields in the report may not be viewable by an engineer with a note “contact manager for additional context on these memory controller parameters.”

The processing may include one or more of semantic relationship mapping to identify connections between different knowledge areas (e.g., identifying relationships between different domains, contextual relevance processing (e.g., understating the context of the data 102 such as a bug to create a context profile and to connect the current request to historical patterns and to establish relevance framework), generating a context-aware prompt to create optimized search queries based on user input (e.g., transforming user intent (description of the issue/bug in data 102) and applying security constraints to optimize the prompts to increase relevance and accuracy), generating a vector-based knowledge retrieval to search for information using similarity matching (e.g., executing optimized prompts against vector indices that are mathematical representations of text that capture meaning and allows the system to find similar content even when different words are used) to compute similarity matches across different domains in order to rank and prioritize information based on contextual relevance while maintaining security boundaries), and/or performing zero-knowledge extraction for processing sensitive information while maintaining privacy (e.g., processing sensitive information without exposing protected content by applying privacy-preserving transformations to the retrieved data and by ensuring that the delivered data complies with privacy rules by sanitizing the data through extraction of private information).

As an example, semantic relationship mapping may be used for AI model training in order to teach the model that concepts in different technical area relate to one another. Semantic relationship mapping may be used in bug processing to associate a current issue to related components that may be affected. As an example, contextual relevance processing may be used for AI model training to recognize patterns in how issues are described in different contexts. The contextual relevance may be used for bug processing to associate current issues with similar historical patterns. For example, a tester may report a timing issue and the context may be recognized in the audio subsystem and further similar timing issues from previous audio projects may be identified while excluding unrelated timing issues from other subsystems. As an example, context-aware prompt generation may be used for AI model training to improve how the model generates effective search strategies while for bug processing it may transform the user's description into structured queries to find relevant information. As an example, when a developer enters “button does not work sometimes” a prompt may be generated to search for “intermittent UI element failure” and may include related terms such as “event handler” and “input validation.” As an example, the vector-based knowledge retrieval may be used for AI model training to teach the model to find relevant information across different data sources while it may be used for bug processing to find similar issues and solutions from the knowledge base. For example, when searching for a “memory corruption” issue, the system may find relevant results regarding “buffer overflow” and “pointer errors” because of semantically being similar in the vector space. As an example, zero-knowledge extraction may be used for training an AI model to work with data that it does not have direct access to and may be used for bug processing to provide useful information without exposing protected details. For example, when a team needs access to information from a confidential project, the system may indicate that “similar issues were resolved by adjusting timing parameters” without revealing the actual code or specific implementational details from the project. In other words, the processing module 420 is configured for contextual understanding and secure information retrieval that generates secure and optimized prompts for data retrieval.

Accordingly, the processing module 420 is configured to process the data in order to understand the intent of the data 102 (e.g., context). The processing module 420 is further configured to determine semantic connections to improve information relevancy, optimize prompts by providing more accurate prompts/responses, improve comprehensive results by providing cross-domain knowledge, protecting sensitive information by performing privacy-preserving transformation, and provide end-to-end security without compromising information quality.

It is appreciated that the output of the security module 410 and/or processing module 420 may be used to filter contents from the databases 140 and 150 in order to ensure that sensitive data is masked according to the permission boundaries and further to ensure that the appropriate data is being used and provided, e.g., to the recommendation module 440.

The recommendation module 440 may access the AI model and based on the processed data provided by the security module 410 and processing module 420 and having access to the databases 140 and 150 for historical data as well as user specific data, the recommendation module 440 may generate one or more recommendations to be provided as AI data 112 to the user. The databases 140 and 150 may store data associated with teams, projects, rules, personalized preferences, prior tickets for bugs/issue, etc. In other words, the recommendation module 440 may combine all processed data and create a final recommendation for the user. As a nonlimiting example, a designer may open a new ticket and may be provided recommendations for the fields of the ticket based on the designer's past tickets and/or similar tickets across the enterprise from database 140. It is appreciated that use of two databases is for illustrative purposes only and should not be construed as limiting the scope of the embodiments. For example, a single database may be used or more than two databases may be used. It is appreciated that the AI module 110 provides a system learning option by learning from prior and historical data of requests, e.g., tickets for bugs/issues, as well as providing a personalized learning option by learning from a user specific preferences to tailor the AI model and to provide recommendations based on the learned behavior.

Accordingly, the embodiments provide a real-time AI analysis of the request, e.g., ticket, content based on historical patterns while preserving data privacy boundaries, e.g., from one user to the another, from one group of users to another group, etc. It is appreciated that AI module 110 enables the electronic tracking system 130 to be provided with a more comprehensive set of data related to the request as well as ensuring that the provided data is more precise and accurate, thereby reducing the amount of time that may be needed to address the request. Moreover, since the AI module 110 is a standalone module that is separate from the electronic tracking system 130, no changes are needed to be made to the electronic tracking system 130. It is appreciated that in one nonlimiting example, the AI module 110 may interact with the electronic tracking system 130 via an intermediary component such as an application programming interface (API) that is provided by the electronic tracking system 130.

It is appreciated that the data 102, e.g., requests, tickets for issue/bug, etc., that are generated may be stored and be later used to tune or modify the AI model, from time to time. Moreover, it is appreciated that the processed data from the security module 410, processing module 420, and/or recommendation module 440 may also be used by the adaptive tuning and the learning module 430 to complement data 102 in order to tune the AI model. The modified AI model may be stored for later use. It is appreciated that in one nonlimiting example each project may be divided into a plurality of milestones and where the AI model is updated and modified at the end of each milestone. It is appreciated that in some examples, feedback from one or more users interacting with the electronic tracking system 130 may also be used by the adaptive turning and the learning module 430 when tuning the AI model. The feedback may be changes being made to the submitted request, e.g., adjusting the priority field. As such, corrections/adjustments being made are considered to update/tune the AI model.

FIG. 5 depicts an illustrative flow diagram for performing a security operation associated with the AI module to provide secure data according to one aspect of the present embodiments. At step 510, a user request authentication is received. For example, authentication request may be based on the data 102 that is received when a verifier is generating the request. At step 520, a token is generated based on the authentication. At step 530, a secure access token is generated for a prompt system based on the generated token (this may also be referred to as token provisioning). At step 540, the token and the prompt are used to generate token-embedded prompt. At step 550, the token-embedded prompt is sent to retrieve the appropriate data. For example, the token-embedded prompt may be sent to the database 140 and/or 150 and/or to a memory component storing the AI model to retrieve data/content. At step 560, the content is filtered based on the token-embedded prompt (e.g., sanitizing the data or masking information that the user should not have access to) to generate a secure data associated with the user. At step 570, the secure data associated with the user may be provided.

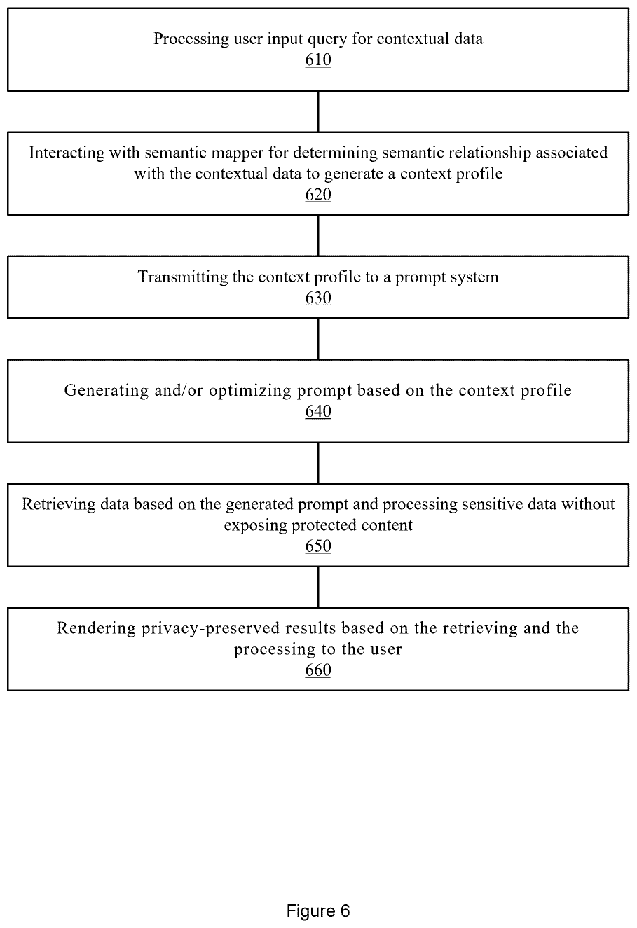

FIG. 6 depicts another illustrative flow diagram for performing an operation within the AI module to provide privacy-preserved results according to one aspect of the present embodiments. At step 610, a user input query (e.g., data 102) is processed for identifying contextual data. For example, a context vector may be computed as well as input categorization, relevance evaluation and semantic mapping interaction in order to generate the context profile and the semantic relationship. At step 620, the semantic mapper is interacted with for determining semantic relationship associated with the contextual data to generate a context profile. For example, cross domain relationship is identified, the sematic vector is analyzed, and conceptual similarity is computed to generate/determine the semantic relationship for a contextual engine. At step 630, the context profile is transmitted to a prompt system, e.g., a large language model (LLM). At step 640, a prompt is generated and/or optimized based on the context profile. At step 650, data is retrieved based on the generated prompt and the sensitive data is processed without exposing the protected content. At step 660, privacy-preserved results are rendered based on the retrieving and the processing to the user. It is appreciated that the vector similarity may be computed and processed along with security-bounded data retrieval across domains to fetch the information being requested. The fetched information may be sanitized by extracting sensitive information or by masking the sensitive information.

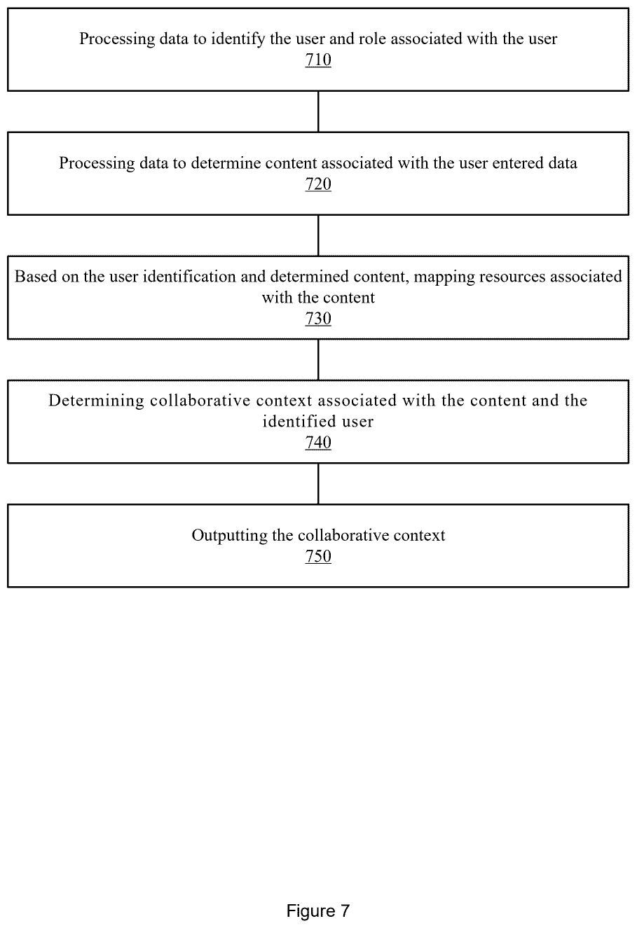

FIG. 7 depicts an illustrative flow diagram for determining collaborative context associated with an issue/bug and project according to one aspect of the present embodiments. At step 710, data (e.g., data 102) is processed to identify the user and role associated with the user. For example, users may be authenticated and verified and a role graph may be traversed. At step 720, the data (e.g., data 102) is processed to determine content associated with the user entered data (e.g., data 102). For example, the content may be classified, its criticality may be assessed, etc. At step 730, resources associated with the content are mapped based on the user identification and the determined content. At step 740, collaborative context associated with the content and the identified user is determined. At step 750, the collaborative context is output. In other words, the team context may be analyzed and relevant team members may be identified based on the context. It is appreciated that the collaborative context may be determined based on relationship graph construction, role classification, team hierarchy mapping, etc.

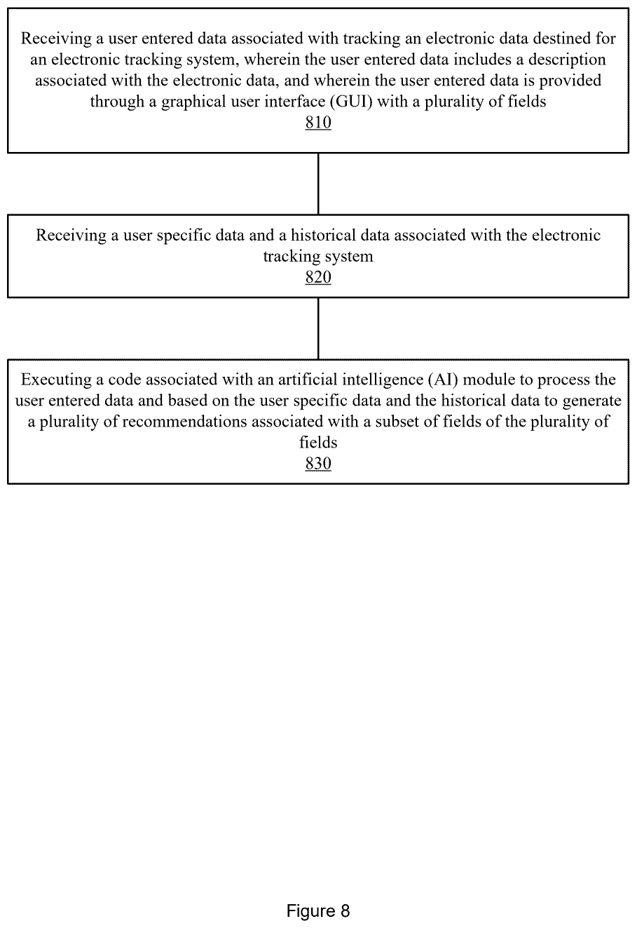

FIG. 8 depicts an illustrative flow diagram for processing data associated with issue/bug to provide intelligent data associated with the issue/bug and project according to one aspect of the present embodiments. At step 810, a user entered data associated with tracking/generating an electronic data, e.g., bug/issue, etc., destined for an electronic tracking system is received, as described above. The user entered data is provided through a GUI with a plurality of fields and includes a description associated with the bug/issue and/or managing the project At step 820, a user specific data and a historical data associated with the electronic tracking system is received, as described above. At step 830, a code associated with an AI module is executed to process the user entered data and based on the user specific data and the historical data to generate a plurality of recommendations associated with a subset of fields of the plurality of fields, as described above.

FIG. 9 is a block diagram illustrating an example of a computing system/device used to support data processing associated with bug/issue and project management to provide intelligent data according to one aspect of the present embodiments.

In the example of FIG. 9, the system 900 includes a processing unit 902, an interface bus 911, and an input/output (“IO”) unit 920. Processing unit 901 includes a processor 902, main memory 904, system bus 911, static memory device 906, bus control unit 905, and mass storage memory 908. Bus 911 is used to transmit information between various components and processor 902 for data processing. Processor 902 may be any of a wide variety of general-purpose processors, embedded processors, or microprocessors such as ARM® embedded processors, Intel® Core™2 Duo, Core™2 Quad, Xeon®, Pentium™ microprocessor, AMD® family processors, MIPS® embedded processors, RISC-V, or Power PC™ microprocessor.

Main memory 904, which may include multiple levels of cache memories, stores frequently used data and instructions. Main memory 904 may be RAM (random access memory), MRAM (magnetic RAM), or flash memory. Static memory 906 may be a ROM (read-only memory), which is coupled to bus 911, for storing static information and/or instructions. Bus control unit 905 is coupled to buses 911-912 and controls which component, such as main memory 904 or processor 902, can use the bus. Mass storage memory 908 may be a magnetic disk, solid-state drive (“SSD”), optical disk, hard disk drive, floppy disk, CD-ROM, and/or flash memories for storing large amounts of data.

I/O unit 920, in one example, includes a display 921, keyboard 922, cursor control device 923, decoder 924, and communication device 925. Display device 921 may be a liquid crystal device, flat panel monitor, cathode ray tube (“CRT”), touch-screen display, or other suitable display device. Display 921 projects or displays graphical images or windows. Keyboard 922 can be a conventional alphanumeric input device for communicating information between computer system 900 and computer operators. Another type of user input device is cursor control device 923, such as a mouse, touch mouse, trackball, or other type of cursor for communicating information between system 900 and users.

Communication device 925 is communicatively coupled to bus 912 for accessing information from remote computers or servers through wide-area network. Communication device 925 may include a modem, a router, or a network interface device, or other similar devices that facilitate communication between computer 900 and the network. In one aspect, communication device 925 is configured to perform wireless functions.

It is appreciated that a processor (e.g., accelerator 125) used for generating an AI model, as described above, or for executing the AI model may be based on a hardware architecture for ML, as described in FIGS. 10A-10B and 11, which includes at least a host, a memory, a core, a data streaming engine, an instruction-streaming engine, and an engine such as an inference engine. The core is configured to interpret a plurality of AI commands/instructions, e.g., ML operation, for an AI operation and/or data received from the host and coordinate activities of the streaming and the inference engines based on the data in the received AI commands. The inference engine may include a dense operation engine and an irregular operation engine. The dense operation engine is an engine that is optimized to efficiently process dense data with regular operations, e.g., matrix operations such as multiplication, matrix manipulation, tanh, sigmoid, etc. On the other hand, the irregular operation engine is an engine that is optimized to efficiently process sporadic data with irregular operations, e.g., memory transpose, addition operation, operations on irregular data structures (such as trees, graphs, and priority queues). In some embodiments, the core may coordinate some of the instructions received from the host to be processed. In some embodiments, the core may be a general processor, e.g., a CPU, etc.

Specifically, the core is configured to divide the plurality of AI commands between the core and the inference engine for efficient execution thereof. The AI commands and relevant data thereof to be executed by the inference engine are transmitted from the core and the memory to the instruction-streaming engine and the data streaming engine for efficient streaming to the inference engine. The data and instruction steaming engines are configured to send one or more data streams and AI commands to the inference engine in response to the received programming instructions from the core. It is appreciated that, in some embodiments, the AI commands being transmitted from the core to the data/instruction-streaming engines is in a function call format, therefore enabling different processors with different instruction set architectures to be programmed using one type of instruction set architecture. To the core, the operation being performed is a write operation into a memory component, but in reality the operation being done is passing on specific instructions along with their associated data via a function call to the streaming engines for transmission to the inference engine where they can be executed. The inference engine is configured to process the instruction/data streams received from the data/instruction stream engines for the ML operation according to the programming instructions received from the instruction/data streaming engines.

It is appreciated that the embodiments provide hardware support to streamline data/instruction flow, the AI hardware architecture improves system-level performance by significantly reducing the hardware overhead involved in moving data and/or instruction in existing computing architectures. Moreover, the programming instruction set reduces the number of instructions required to perform certain tasks, e.g., processing, moving data, loading data, etc. The proposed AI hardware architecture works well with existing software frameworks and code and may be applied to a wide variety of ML algorithms and neural networks including but not limited to convolution neural network (CNN), recurrent neural network (RNN), gradient boosting machine (GBM), generative adversarial neural network, decision trees, random forest, support vector machine (SVM), clustering, Markov random field (MRF), LLM, etc.

FIG. 10A-10B depict illustrative examples of a hardware-based programmable system (accelerator) configured to support machine learning and AI related operations according to one aspect of the present embodiments.

FIG. 10A depicts an example of a diagram of a hardware-based programmable system/architecture 1001 configured to support machine learning. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The architecture 1001 may include a host 1010 coupled to a memory (e.g., DDR) 1020 and a core engine 1030. The memory 120 may be coupled to a data streaming engine 140. The core 1030 is coupled to an instruction-streaming engine 1050, which is coupled to the data streaming engine 1040. The core 130 is also coupled to a general processor 1065. In some embodiments, the general processor 1065 can be part of the core 1030. The instruction-streaming engine 1050 and the data streaming engine 1040 are coupled to the dense operation engine 1061 and irregular operation engine 1063. In some embodiments, the dense operation engine 1061 and the irregular operation engine 1063 are part of an inference engine 1060 discussed below. Each of the engines in the architecture 1001 is a dedicated hardware block/component including one or more microprocessors and on-chip memory units storing software instructions programmed by a user for various machine learning operations. When the software instructions are executed by the microprocessors, each of the hardware components becomes a special purposed hardware component for practicing certain machine learning functions as discussed in detail below. In some embodiments, the architecture 1001 is on a single chip, e.g., a system-on-chip (SOC).

The dense operation engine 1061 is an engine that is optimized to efficiently process dense data with regular operations, e.g., matrix operations such as multiplication, matrix manipulation, tanh, sigmoid, etc. On the other hand, the irregular operation engine 1063 is an engine that is optimized to efficiently process sporadic data with irregular operations, e.g., memory transpose, addition operation, operations on irregular data structures (such as trees, graphs, and priority queues). In some embodiments, the core may coordinate some of the instructions received from the host to be processed by the general processor 1065, e.g., a CPU, etc. It is appreciated that the memory 1020 may be coupled to a DMA engine 1022 and NIC 1024.

FIG. 10B depicts an example of a diagram of a hardware-based programmable system/architecture 1000 configured to support machine learning. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In 1000 may include a host 1010 coupled to a memory (e.g., DDR) 1020 and a core engine 1030. The memory 1020 may be coupled to a data streaming engine 1040. The core 1030 is coupled to an instruction-streaming engine 1050, which is coupled to the data streaming engine 1040. The instruction-streaming engine 1050 and the data streaming engine 1040 are coupled to the inference engine 1060. Each of the engines in the architecture 1000 is a dedicated hardware block/component including one or more microprocessors and on-chip memory units storing software instructions programmed by a user for various machine learning operations. When the software instructions are executed by the microprocessors, each of the hardware components becomes a special purposed hardware component for practicing certain machine learning functions as discussed in detail below. In some embodiments, the architecture 1000 is on a single chip, e.g., a system-on-chip (SOC).

The host 1010 may be a processing unit configured to receive or generate data to be analyzed and/or inferred via machine learning. For a non-limiting example, the host 1010 is configured to receive an image, wherein the subject of the image, e.g., a house, a dog, a cat, etc., is to be identified by the ML or AI operation through inference. It is appreciated that while the embodiments are described with respect to identifying the subject matter in the image, the embodiments are not limited thereto and the data received by the host 1010 can be of any type. In some embodiments, the host 1010 may also include and provide training data that may be used by the inference engine 1060 for the ML operation to identify the subject in the image, wherein the training data may optionally include a polynomial with their respective weights. In some embodiments, the inference engine 1060 includes the dense operation engine 1061 and irregular operation engine 1063 depicted in FIG. 10A and discussed above. In some embodiments, the host 1010 is configured to transmit and save the data to be inferred and/or the training data to the memory 1020. In some embodiments, the host 1010 is configured to provide a plurality of commands to the core 1030 to coordinate various components in the architecture 1000 to perform a ML operation on the data. For a non-limiting example, the memory 1020 may receive the data to be inferred and/or the training data from a networking component, e.g., network interface card (NIC) 1024, via a direct memory access engine (DMA) 1022 per a load command from the host 1010. In some embodiments, the host 1010 is configured to communicate with the memory 1020 and the core 1030 via a PCIe interface/controller.

The core 1030 is a processing engine coupled to the host 1010 and configured to receive and interpret a plurality of ML commands for a ML operation from the host 1010. In some embodiments, the core 1030 is configured to save the plurality of ML commands in a ML command RAM 1026. It is appreciated that the ML commands may be stored in the memory 1020 instead of using ML command RAM 1026. In some embodiments, the ML instruction RAM 1026 may be integrated with the NIC 1024 thereby reducing extra hops and accelerating access to the memory 1020 and/or the ML instruction RAM 1026. Once the ML commands have been interpreted, the core 1030 is configured to coordinate activities of other components on the architecture 1000, e.g., the data streaming engine 1040, the instruction-streaming engine 1050, the inference engine 1060, according to the received ML commands. In some embodiments, the core 1030 is an FPGA, a CPU, or a microcontroller.

In some embodiments, the core 1030 is configured to execute any software code written through a common high-level language. The core 1030 is configured to process a plurality of performance non-critical operations, e.g., data/instruction preparatory work, data collection, data mapping, etc. In some embodiments, the core 1030 may also be configured to breakdown the received ML commands into performance critical and noncritical operations/tasks such that the performance noncritical operations can be processed by the core 1030 and the performance critical operations (e.g., matrix multiplication) can be processed by the inference engine 1060. In other words, the core 1030 is configured to divide the plurality of ML commands between the core 1030 and the inference engine 1060 for efficient execution thereof. In some embodiments, the core 1030 may also be configured to assign/divide the plurality of ML commands (also referred to as tasks or sub-tasks) to various components, e.g., the inference engine 1060, for processing. In some embodiments, the core 1030 is configured to allocate one or more locations in the memory 1020 for storing of tasks/commands, the data, result after the data is processed, etc. to be accessed and used by the core 1030 or other components, e.g., inference engine 1060, in the architecture 1000. As such, the core 1030 and the inference engine 1060 are configured to execute the entire ML algorithms and the operation by themselves instead of having to rely on or require the host 1010 to execute certain ML commands or operations. By supporting and executing the entire ML operation on the programmable hardware architecture 1000, the core 1030 eliminates performance overhead of transferring data to the host 1010 and back to execute any non-supported ML operations and reduces burden on the host 1010 to achieve a higher performance.

The ML commands and relevant data thereof to be executed by the inference engine 1060 is transmitted from the core 1030 and the memory 1020 to the instruction-streaming engine 1050 and the data streaming engine 1040 for efficient streaming to the inference engine 1060. The data/instruction steaming engines 1040-1050 are configured to send one or more data streams and programming instructions to the inference engine 1060 in response to the received ML commands from the core 1030. In some embodiments, the core 1030 is configured to execute one or more library function calls. For a non-limiting example, a library function call used by the core 1030 may be a load command having various parameters, wherein the core 1030 may pass certain parameters to the instruction-streaming engine 1050 via the library function call. Passing of instructions and their associated data from the core 1030 and the memory 1020 to the inference engine 1060 via a function call enables different processors with different instruction set architectures to be programmed using a single type of instruction set architecture. In other words, for core 1030 the operation being performed is a write operation into a special memory location, i.e. instruction-streaming engine 1050, but in reality the operation being done is passing on specific instructions along with their associated data to the streaming engines 1040-1050, via a function call, for transmission to the inference engine 1060 where they can be executed and processed. Accordingly, the function call provides a mechanism to seamlessly merge more than one instruction set architecture using a single instruction set architecture by encapsulating the instruction within the function call and providing the instruction as data to the special memory location, i.e. instruction-streaming engine 1050, inference engine 1060, etc. where it can be processed. The inference engine 1060 is configured to process the data/instruction streams received from the data/instruction stream engines 1040-1050 for the ML operation according to the programming instructions received.

In some embodiments, the instruction-streaming engine 1050 is configured to use the parameters provided by the core 1030, via a function call, to stream the ML commands in a specific instruction set architecture format of the inference engine 1060 to the inference engine 1060. Similarly, the data streaming engine 1040 is configured to fetch the data stored in the memory 1020 based on the parameters provided by the core 1030, via a function call, to stream the data in a specific instruction set architecture format of the inference engine 1060 to the inference engine 1060. It is appreciated that the ML commands in the specific instruction set architecture format and the data are streamed in such a way to reduce the number of required operations. For a non-limiting example, a conventional CPU may require a load, process, and store in order to move one piece of data from one location to the next, however, in some embodiments a streaming mechanism may be used such that data and/or instructions are streamed in a continuous fashion without a need to execute three instructions for each piece of data. For a non-limiting example, the received parameters may be used by the instruction-streaming engine 1050 to configure the data streaming engine 1040 to achieve the streaming load instruction. For another non-limiting example, the instruction-streaming engine 1050 may configure the inference engine 1060 to process data in a highly specific and efficient manner based on the received parameters. Specifically, the instruction-streaming engine 1050 may configure one or more processing elements within the inference engine 1060 to process the stream of data in a specific manner. In some embodiments, the instruction-streaming engine 1050 may also configure on-chip memory on the inference engine 1060 to receive data in a specific manner (e.g., streaming fashion) from the data streaming engine 1040 as described below.

In some embodiments, the core 1030 is configured to break down a top-level task, e.g., a ML operation, specified by the command from the host 1010 into a plurality of sub-tasks and instructor program other components/blocks on the architecture 1000, e.g., the data streaming engine 1040, the instruction-streaming engine 1050, the inference engine 1060, to execute those sub-tasks in a coordinated fashion. In some embodiments, the core 1030 processes performance non-critical operations. Other instructions that are performance critical operations are passed in a function call from the core 1030 to the data streaming engine 1040 and/or the instruction-streaming engine 1050. Programmer having knowledge of the inference engine 1060 architecture, can pass the performance critical operations to the inference engine 1060. The sub-tasks and their associated data may therefore be streamed, using the instruction-streaming engine 1050 and the data streaming engine 1040, to the inference engine 1060, thereby programming the inference engine 1060, as desired. In some embodiments, dense and more regular operations, e.g., matrix operations such as multiplication, matrix manipulation, tanh, sigmoid, etc., may be programmed in a first type of processing unit of the inference engine 1060 while irregular operations, e.g., memory transpose, addition operation, operations on irregular data structures (such as trees, graphs, and priority queues), etc., may be programmed in a second type of processing unit of the inference engine 1060. Hybrid approaches may also be programmed in various types of processing units.

Once programmed, these components/blocks within the inference engine 1060 are responsible for executing the sub-tasks and thus save considerable amount of time and load from the host 1010. It is appreciated that, once the command is broken down to the sub-tasks, certain sub-tasks are being executed by the core 1030 itself but commands for other sub-tasks that are highly specialized and require high performance efficiency are transmitted to the instruction-streaming engine 1050, in a function call. In some embodiments, commands for other sub-tasks that are highly specialized may have a different instruction set architecture and appear to the core 1030 as data being written to a special memory location but in reality the special memory component is the instruction-streaming engine 1050. The instruction-streaming engine 150 may use the instructions received with the different instruction set architecture with, for non-limiting examples, one or more of different addressing modes, different instructions, different native data types, different registers, different memory architecture, different interrupts, etc., to stream the sub-tasks and any data associated therewith to the inference engine 1060 for execution and further processing. It is further appreciated that the core 1030 may generate certain sub-tasks that occur at a frequency less than every cycle for certain components of the architecture 1000, thereby allowing such components to run at a lower frequency than the rest of the architecture 1000, if needed. In some embodiments, any sub-task or programming instructions that are infrequent is executed by the core 1030 while repetitive and more frequent programming instructions are executed by a dedicated component of the architecture 1000, e.g., inference engine 1060.

Traditionally, one load instruction is typically needed to load each chunk of data from a memory. The memory 1020 is configured to maintain and provide the data to be inferred and/or the training data to the data streaming engine 1040, which is configured to load the data onto on-chip memory (OCM) of the inference engine 1060 in a streaming fashion via a single instruction, thereby reducing the number of instructions needed to load the data. Specifically, the data streaming engine 1040 is configured to apply one (instead of multiple) load instruction to load a data stream 1090 received from the memory 1020 by specifying the manner in which the data is to be loaded and the address of the memory 1020, etc. Here, the streaming load instruction may specify one or more of the starting address and the pattern (e.g., the length, the stride, the counts, etc.) of the data to be loaded, thereby eliminating the need for one load instruction for each section/chunk of data.

FIG. 11 depicts an illustrative example of an accelerator engine including a plurality of processing tiles according to one aspect of the present embodiments. The accelerator engine 1160 include a plurality of processing tiles, e.g., tiles 0, . . . , 63, arranged in a two-dimensional array of a plurality of rows and columns, e.g., 8 row by 8 columns. Each processing tile (e.g., tile 0) includes at least one on-chip memory (OCM) e.g., 1110 (or 1112, 1114, 1116), one POD unit, e.g., 1120 (or 1122, 1124, 1126), and one processing engine/element (PE), e.g., 1130 (or 1132, 1134, 1136). Here, the OCMs in the processing tiles are configured to receive data from the data streaming engine 1040 in a streaming fashion as described, for a non-limiting example, in FIG. 2 above. The OCMs enable efficient local access to data per processing tile. The processing units, e.g., the PODs and the PEs are configured to perform highly specialized tasks, e.g., dense and sparse computations of an AI operation on the received data in the OCMs, respectively. Both the PODs and the PEs can be programmed according to the programming instructions received from the instruction-streaming engine 1050. Accordingly, the data is received and processed by each processing tile as an input data stream and the result is output by each processing tile as a stream of data, thereby reducing the number of instructions required to perform the ML operation substantially. For a non-limiting example, one streaming load instruction replaces thousands of conventionally load instructions. Similarly, one streaming add instruction replaces thousands of conventionally add instructions, and one streaming store instruction replaces thousands of conventionally store instructions.

In some embodiments, a plurality of processing tiles forms a processing block, e.g., tiles 0-3 forms processing block 1 and the processing tiles within each processing block are coupled to one another via a routing element, e.g., tiles 0-3 are coupled to one another via routing element 1140 to form processing block 1. It is appreciated that the processing blocks may be coupled to one another in the same row or column via a plurality of routing elements. For the example as shown in FIG. 11, there are four processing blocks in each row and column of the two-dimensional array. It is further appreciated that the number and/or types of components within each processing tile, the formation of the processing blocks, the number of processing tiles in each processing block, and the number of processing blocks in each row and column of the accelerator engine 1160 are for illustration purposes only and should not be construed as limiting the scope of the embodiments. In some embodiments, the same number of PE and POD may be used for each tile, and the same number of blocks may be used in each row and column in order to provide flexibility and scalability.

In some embodiments, the OCM in each processing tile may include a number of memory blocks of any size each having one or more read and write ports (not shown). Each OCM block may further include a read queue and a write queue, which buffer the read and write requests of data stored in the OCM, respectively. In some embodiments, the OCMs of processing tiles in the same processing block support aligned-reads, wherein data allocated and maintained in these OCMs can be retrieved directly to the corresponding PODs or PEs in the tiles via at least one read port in each of the OCMs aligned with the corresponding input lanes in the PODs or PEs. Such aligned-reads reduce data swizzles for ML operations, e.g., common matrix multiply operations, on data distributed across multiple processing tiles to reduce both the power and the latency of reading data into the PODs or PEs. Here the data to be read needs to be allocated in the OCMs in such a way that aligned-reads work, e.g., the data may be allocated by breaking down its address (X bits) into POD/PE no. (X-Y bits) and OCM address (Y bits). It is appreciated that the specific implementation discussed is for illustration purposes only and should not be construed as limiting the scope of the embodiments.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
an electronic tracking system; and
at least one or more databases configured to store user specific data and historical data associated with the electronic tracking system,
a processor configured to receive a user entered data associated with at least one or more of tracking or generating an electronic data destined for the electronic tracking system, wherein the user entered data is provided through a graphical user interface (GUI) with a plurality of fields, wherein the user entered data includes a description associated with the electronic data that is provided through a field of the plurality of fields, and wherein the processor is configured to execute a code associated with an artificial intelligence (AI) module to process the user entered data and based on the user specific data and the historical data to generate a plurality of recommendations associated with a subset of fields of the plurality of fields.

2. The system of claim 1, wherein the AI module is configured to fill the subset of fields of the plurality of fields based on the plurality of recommendations.

3. The system of claim 2, wherein the filled subset of fields is user modifiable.

4. The system of claim 1, the subset of fields includes at least one or more of priority associated with the electronic data, a sub-type associated with the electronic data, identification of a related component to the electronic data, identification of whether the electronic data is post tape out or pre-tape out, and identification with timing associated with the electronic data.

5. The system of claim 1, wherein the processor executing the code associated with the AI module is configured to retrieve a machine learning (ML) model from the at least one or more databases, wherein the ML model is used in generating the plurality of recommendations.

6. The system of claim 1, wherein the processor is an accelerator.

7. The system of claim 1, wherein the processor executing the code associated with the AI module is configured to perform a security operation associated with the user, wherein the security operation is at least one or more of permission boundaries, access control, security token generation, security token provisioning, and an audit event.

8. The system of claim 7, wherein the processor executing the code associated with the AI module is configured to perform one or more processing associated with context analysis of the electronic data, processing associated with semantic mapping for the electronic data, and prompt generation to subsequently be used to generate the plurality of recommendations.

9. The system of claim 1, wherein the processor is configured to store at least a subset of user entered data in the at least one or more databases to update the user specific data and to update the historical data, and wherein the processor is further configured to tune the AI module based on the subset of user entered data.

10. The system of claim 1, wherein the AI module is separate from the electronic tracking system.

11. The system of claim 1, wherein the processor is configured to:
receive a user request authentication message;
determine whether the user is authenticated;
generate a token based on determining whether the user is authenticated;
generate a secure access token for a prompt generated by the processor executing the code associated with the AI module;
generate a token-embedded prompt based on the generated token and further based on the generated prompt; and
filter content in the at least one or more databases based on the generated token-embedded prompt to generate the user specific data.

12. The system of claim 1, wherein the processor is configured to:
process the user entered data for contextual data;
determine semantic relationship associated with the contextual data to generate a context profile;
generate a prompt based on the context profile; and
retrieve the user specific data based on the generated prompt.

13. The system of claim 12, wherein the processor is configured to provide the user specific data to the user.

14. The system of claim 1, wherein the processor is configured to:
process the user entered data to identify the user and a role associated with the user;
process the user entered data to determine a content of the user entered data;
determine collaborative context based on the content and identification of the user; and
output the collaborative context.

15. The system of claim 1, wherein the processor is further configured to train an AI model based on the historical data associated with the electronic tracking system.

16. A system, comprising:
a processor configured to receive a user entered data associated with at least one or more of tracking or generating an electronic data destined for a tracking system, wherein the user entered data is provided through a graphical user interface (GUI) with a plurality of fields, and wherein the user entered data includes a description associated with the electronic data provided through a field of the plurality of fields; and
at least one or more databases configured to store user specific data and historical data associated with the electronic tracking system,
wherein the processor is configured to execute a code associated with an artificial intelligence (AI) module to process the user entered data and based on the user specific data and the historical data to generate a plurality of recommendations associated with a subset of fields of the plurality of fields.

17. The system of claim 16, wherein the AI module is configured to fill the subset of fields of the plurality of fields based on the plurality of recommendations.

18. The system of claim 17, wherein the filled subset of fields is user modifiable.

19. The system of claim 16, the subset of fields includes at least one or more of priority associated with the electronic data, a sub-type associated with the electronic data, identification of a related component to the electronic data, identification of whether the electronic data is post tape out or pre-tape out, and identification with timing associated with the electronic data.

20. The system of claim 16, wherein the processor executing the code associated with the AI module is configured to retrieve a machine learning (ML) model from the at least one or more databases, wherein the ML model is used in generating the plurality of recommendations.

21. The system of claim 16, wherein the processor is an accelerator.

22. The system of claim 16, wherein the processor executing the code associated with the AI module is configured to perform a security operation associated with the user, wherein the security operation is at least one or more of permission boundaries, access control, security token generation, security token provisioning, and an audit event.

23. The system of claim 22, wherein the processor executing the code associated with the AI module is configured to perform one or more processing associated with context analysis of the electronic data, processing associated with semantic mapping for the electronic data, and prompt generation to subsequently be used to generate the plurality of recommendations.

24. The system of claim 16, wherein the processor is configured to store at least a subset of user entered data in the at least one or more databases to update the user specific data and to update the historical data, and wherein the processor is further configured to tune the AI module based on the subset of user entered data.

25. The system of claim 16, wherein the AI module is separate from the electronic tracking system.

26. The system of claim 16, wherein the processor is configured to:
receive a user request authentication message;
determine whether the user is authenticated;
generate a token based on determining whether the user is authenticated;
generate a secure access token for a prompt generated by the processor executing the code associated with the AI module;
generate a token-embedded prompt based on the generated token and further based on the generated prompt; and
filter content in the at least one or more databases based on the generated token-embedded prompt to generate the user specific data.

27. The system of claim 16, wherein the processor is configured to:
process the user entered data for contextual data;
determine semantic relationship associated with the contextual data to generate a context profile;
generate a prompt based on the context profile; and
retrieve the user specific data based on the generated prompt.

28. The system of claim 27, wherein the processor is configured to provide the user specific data to the user.

29. The system of claim 16, wherein the processor is configured to:
process the user entered data to identify the user and a role associated with the user;
process the user entered data to determine a content of the user entered data;
determine collaborative context based on the content and identification of the user; and
output the collaborative context.

30. The system of claim 16, wherein the processor is configured to train an AI model based on the historical data associated with the electronic tracking system.

31. A method, comprising:
receiving a user entered data associated with at least one or more of tracking or generating an electronic data destined for an electronic tracking system, wherein the user entered data is provided through a graphical user interface (GUI) with a plurality of fields and includes a description associated with the electronic tracking system;
receiving a user specific data and a historical data associated with the electronic tracking system; and
executing a code associated with an artificial intelligence (AI) module to process the user entered data and based on the user specific data and the historical data to generate a plurality of recommendations associated with a subset of fields of the plurality of fields.

32. The method of claim 31 further comprising:
filling the subset of fields of the plurality of fields based on the plurality of recommendations.

33. The method of claim 32, wherein the filled subset of fields is user modifiable.

34. The method of claim 31, wherein the subset of fields includes at least one or more of priority associated with the electronic data, a sub-type associated with the electronic data, identification of a related component to the electronic data, identification of whether the electronic data is post tape out or pre-tape out, and identification with timing associated with the electronic data.

35. The method of claim 31 further comprising retrieving a machine learning (ML) model from the at least one or more databases, wherein the ML model is used in generating the plurality of recommendations.

36. The method of claim 31 further comprising perform a security operation associated with the user, wherein the security operation is at least one or more of permission boundaries, access control, security token generation, security token provisioning, and an audit event.

37. The method of claim 36, wherein the performing the security operation includes at least one or more of processing associated with context analysis of the electronic data, processing associated with semantic mapping for the electronic data, and prompt generation to subsequently be used to generate the plurality of recommendations.

38. The method of claim 31 further comprising storing at least a subset of user entered data to update the user specific data and to update the historical data, and tuning the AI module based on the subset of user entered data.

39. The method of claim 31 further comprising:
receiving a user request authentication message;
determining whether the user is authenticated;
generating a token based on determining whether the user is authenticated;
generating a secure access token for a prompt generated by the processor executing the code associated with the AI module;
generating a token-embedded prompt based on the generated token and further based on the generated prompt; and
filtering content in the at least one or more databases based on the generated token-embedded prompt to generate the user specific data.

40. The method of claim 31 further comprising:
processing the user entered data for contextual data;
determining semantic relationship associated with the contextual data to generate a context profile;
generating a prompt based on the context profile; and
retrieving the user specific data based on the generated prompt.

41. The method of claim 40 further comprising providing the user specific data to the user.

42. The method of claim 31 further comprising:
processing the user entered data to identify the user and a role associated with the user;
processing the user entered data to determine a content of the user entered data;
determining collaborative context based on the content and identification of the user; and
outputting the collaborative context.

43. The method of claim 31 further comprising training an AI model based on the historical data associated with the electronic tracking system.

44. A system comprising:
a means for receiving a user entered data associated with at least one or more of tracking or generating an electronic data destined for an electronic tracking system, wherein the user entered data is provided through a graphical user interface (GUI) with a plurality of fields and includes a description associated with the electronic data;
a means for receiving a user specific data and a historical data associated with the electronic tracking system; and
a means for executing a code associated with an artificial intelligence (AI) module to process the user entered data and based on the user specific data and the historical data to generate a plurality of recommendations associated with a subset of fields of the plurality of fields.
